(19) United States
(12) Patent Application Publication
(10) Pub. No.: US 2006/0028028 A1
(43) Pub. Date: Feb. 9, 2006

(54) Tilt-latch for a sash window

(76) Inventor: Steven E. Schultz, Rockford, IL (US)

Correspondence Address: PAUL J. NYKAZA, ESQ.;WALLENSTEIN WAGNER & ROCKEY, LTD., 53RD FLOOR, 311 SOUTH WACKER DRIVE, CHICAGO, IL, 60606-6630, US

(21) Appl. No.: 10/895,023

(22) Filed: Jul. 20, 2004

(51) Int. Cl. E05C 1/10

(52) U.S. Cl. 292/175

(57) ABSTRACT

A tilt-latch (10) for a sash window (12) is disclosed. The tilt-latch (10) has a housing (40) adapted to be supported by a top rail (20) of the sash window (12). The housing (40) has an outward end opening (58) and an aperture (68). A latch bolt (42) is disposed within the housing (40) and has a nose (88) adapted for engaging a respective one of the guide rails (16). The latch bolt (42) has an extended position, an intermediate position and a retracted position. An actuator (44) is connected to the latch bolt (42). The housing (40), the latch bolt (42) and the actuator (44) have cooperative structure such that the actuator (44) is connectable with the latch bolt (42) only when the latch bolt (42) is in the intermediate position.

### TECHNICAL FIELD

The present invention relates to a tilt-latch for a pivotally mounted sash window assembly, and more particularly, to a tilt-latch assembled from components having structure to prevent or resist disassembly following installation.

### BACKGROUND OF THE INVENTION

A pivotal sash window adapted for installation in a master frame of a sash window assembly is well-known. The sash window assembly typically has opposed, vertically extending guide rails to enable vertical reciprocal sliding movement of the sash window in the master frame while cooperatively engaged with the guide rails. The sash window has a top sash rail, a base and a pair of stiles cooperatively connected together at adjacent extremities thereof to form a sash frame, usually a rectangular frame. Typically, a pair of spaced tilt-latches are installed on, or in, opposite ends of the top sash rail.

Each tilt-latch is generally comprised of a housing having an outward end opening and a latch bolt disposed within the housing. The housing may include an aperture adapted to receive a fastener which affixes the housing of the tilt-latch to the sash frame. A spring disposed within the housing generally biases the latch bolt through the outward end opening to engage the guide rails of the master frame. An actuator is operably associated with the latch bolt to allow for actuation of the latch bolt. The actuator typically includes a fingerhold, which can be either in the form of a control button extending outward from the surface of the actuator, or a recessed portion extending beneath the surface of the actuator. An operator engages the actuator to actuate the latch bolt wherein the latch bolt is retracted into the housing. This releases the latch bolt from the guide rail. When the latch bolts of the opposed tilt-latches are both actuated, the sash window can then be pivoted away from the master frame.

Tilt-latches can be one of two varieties. In one variety, the actuator and latch bolt are rigidly connected so as to form one component which cannot be separated. When the actuator and latch bolt are one component, the housing typically includes a split portion allowing the housing to outwardly flexed to permit installation of the latch bolt into the housing. Alternatively, the housing can be fabricated from multiple pieces and assembled and sealed around the actuator and latch bolt component such that the latch bolt is installed inside the housing. However, this method of construction results in weaker strength of the housing due to the presence of the split or seam. The housing is not an integral structure. This can possibly result in the latch bolt twisting out of the housing while under load. Also, because of the presence of the split or seam, the housing may fracture more easily while the latch bolt is under load.

In the second variety, the actuator and latch bolt are separate components which are connected during installation into the housing. In this variety,.the housing is typically formed of a single piece of material, and therefore does not include a split or seam as with the other traditional variety. Typically, the latch bolt is installed into the housing through the outward end opening. Then, the actuator is installed such that it operably engages the latch bolt. However, this method of construction and assembly may allow the actuator to disengage from the tilt latch when the latch bolt is under load. In addition, in this variety, one may pry the actuator from the latch bolt.

The present invention is provided to solve these and other problems.

### SUMMARY OF THE INVENTION

The present invention provides a tilt-latch adapted for releasably securing a pivotable sash window to a master frame of a sash window assembly.

The master frame has opposed, vertically extending guide rails. The sash window has a top sash rail, a base and a pair of stiles cooperatively connected together at adjacent extremities to form a frame. The top sash rail may include a pair of openings to accommodate a tilt-latch on each side of the top sash rail.

In accordance with one aspect of the invention, the tilt-latch has a housing adapted to be supported by the top rail. The housing has an outward end opening and an aperture. A latch bolt is disposed within the housing and has a nose adapted for engaging a respective one of the guide rails. The latch bolt has an extended position, an intermediate position and a retracted position. An actuator is connected to the latch bolt through the aperture. The actuator is connectable with the latch bolt only when the latch bolt is in the intermediate position.

In accordance with another aspect of the invention, the housing, the latch bolt and the actuator have cooperative structure such that the actuator is connectable with the latch bolt only when the latch bolt is in the intermediate position.

According to another aspect of the invention, the housing of the tilt-latch has an outward end opening and an aperture. The latch bolt is disposed within the housing and has an extended position, a connecting position and a retracted position. The actuator is releasably connected to latch bolt when latch bolt is in a connecting position. The tilt-latch further has means for preventing the actuator from being disconnected from latch bolt when the latch bolt is spaced from the connecting position.

According to a further aspect of the invention, the tilt-latch has a latch bolt having an extended position, an intermediate position and a retracted position. An actuator is connected to the latch bolt when the latch bolt is positioned in the intermediate position. The tilt-latch has structure to prevent the actuator from being disconnected from the latch bolt when the latch bolt is in the extended position or the retracted position.

Other features and advantages of the invention will be apparent from the following specification taken in conjunction with the following drawings.

### BRIEF DESCRIPTION OF THE DRAWINGS

FIG. 1 is a perspective view of a double-hung sash window assembly utilizing a tilt-latch according to the invention;

FIG. 2 is a perspective view of the tilt-latch utilized in FIG. 1;

FIG. 3 is an exploded perspective view of the tilt-latch;

FIG. 4 is a front elevation view of the tilt-latch;

FIG. 5 is a rear elevation view of the tilt-latch;

FIG. 6A is a cross-sectional view of the tilt-latch taken along line 6A-6A of FIG. 2;

FIG. 6B is a cross-sectional view of the tilt-latch taken along line 6B-6B of FIG. 2;

FIG. 7 is a partial exploded view of the tilt-latch showing an actuator being connected to a latch bolt of the tilt-latch;

FIG. 8 is a perspective view of a latch bolt positioned in a housing of the tilt-latch, the latch bolt being in an intermediate position;

FIG. 8A is a perspective view of a tilt latch including an alternative embodiment of a tilt latch housing;

FIG. 8B is an exploded view of a tilt latch including the alternative housing of FIG. 8A;

FIG. 9 is a partial exploded view of the tilt-latch showing the latch bolt in the intermediate position and an actuator spaced from the housing, a portion of the actuator shown transparent;

FIG. 10 is a perspective view of the actuator being connected to the latch bolt, a portion of the actuator shown transparent;

FIG. 11 is a top perspective view of the actuator connected to the latch bolt, a portion of the actuator shown transparent;

FIG. 12 is a side perspective view of the actuator connected to the latch bolt;

FIG. 13 is a rear perspective view of the actuator connected to the latch bolt, a portion of the latch bolt removed;

FIG. 14 is a perspective view of the tilt-latch with a portion of the actuator shown transparent, and the latch bolt being in an extended position;

FIG. 15 is a perspective view of the tilt-latch with a portion of the actuator shown transparent, and the latch bolt being in a retracted position;

FIG. 16 is an exploded perspective view of a second preferred embodiment of the tilt-latch of the present invention;

FIG. 17 is a cross-sectional view of the second preferred embodiment of the tilt-latch, taken along line 17-17 of FIG. 16;

FIG. 18 is an end view of the tilt-latch of FIG. 16;

FIG. 19 is a perspective view of the latch bolt of the tilt-latch of the second preferred embodiment; and

FIG. 20 is a cross-sectional view of the housing of the tilt-latch of FIG. 16, taken along line 20-20 of FIG. 17.

### DETAILED DESCRIPTION

While this invention is susceptible of embodiment in many different forms, there is shown in the drawings and will herein be described in detail preferred embodiments of this invention with the understanding that the present disclosure is to be considered as an exemplification of the principles of the invention and is not intended to limit the broad aspect of the invention to the embodiments illustrated.

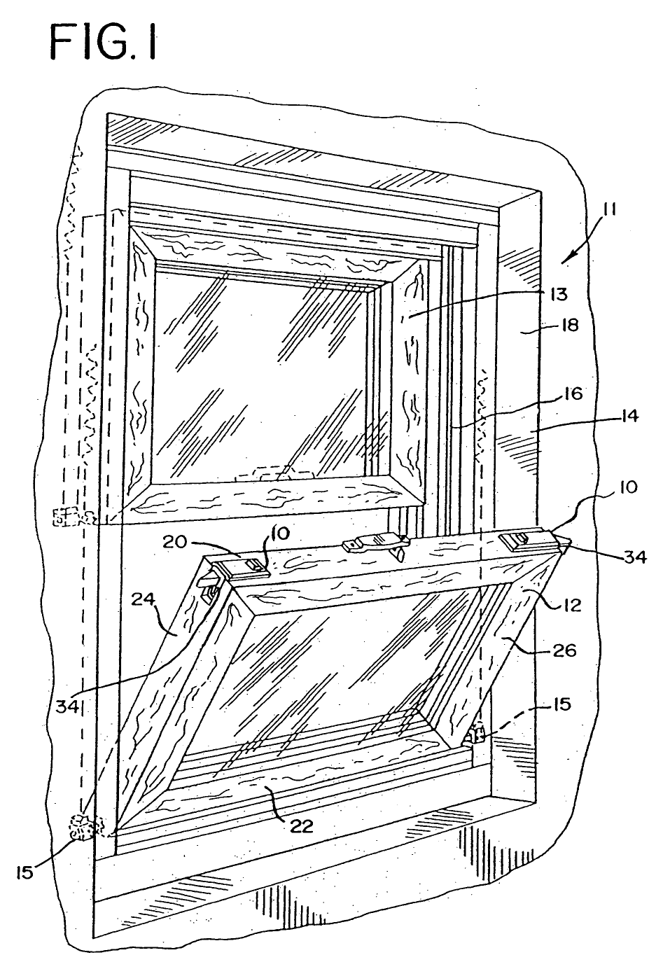

FIG. 1 shows a tilt-latch of the present invention, generally designated with the reference numeral 10, used in a sash window assembly 11. The sash window assembly 11 shown in FIG. 1 is a double-hung window assembly having a pivotal sash window 12 installed in a master frame 14. In this embodiment, the sash window 12 is a lower sash window 12, and an upper sash window 13 is also included. The tilt-latch 10 could also be used in other types of pivotal windows or structures. The sash window 12 is pivotally mounted to the master frame 14 by a pivot-corner/balance shoe assembly 15. As is well known, the master frame 14 has opposed, vertically extending guide rails 16. The sash window 12 has a hollow top sash rail 20, a base 22 and a pair of hollow stiles 24,26, cooperatively connected together at adjacent extremities thereof to form a sash frame, typically rectangular although other shapes are possible. The sash frame could be made from wood, masonite or pressboard. In one preferred embodiment, the sash frame of the sash window 12,14 are made from wood as is the master frame 14. The sash frame could also be made from extrusions or pulltrusions that are filled with fiberglass, epoxy, plastic, or wood chips. As shown in FIG. 1, the top sash rail 20 includes a pair of opposing header slots 34, which were formed as by routing the top sash rail 20. Alternatively, the header slots 34 may be formed by prepunching the top sash rail 20. It is understood that the top sash rail 20, as well as the rest of the frame, could be solid, or hollow. As further shown in FIG. 1, the tilt-latch 10 is mounted on the top rail 20 of the sash window 12. As explained in greater detail below, a separate fastener such as a screw may be used to fasten the tilt-latch 10 to the sash window 12.

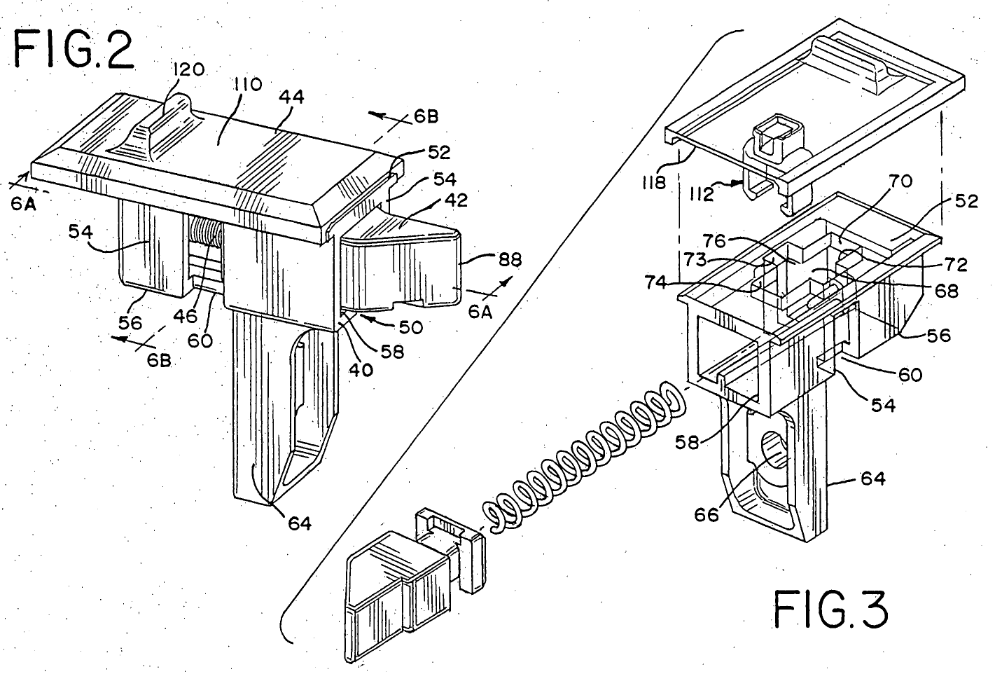

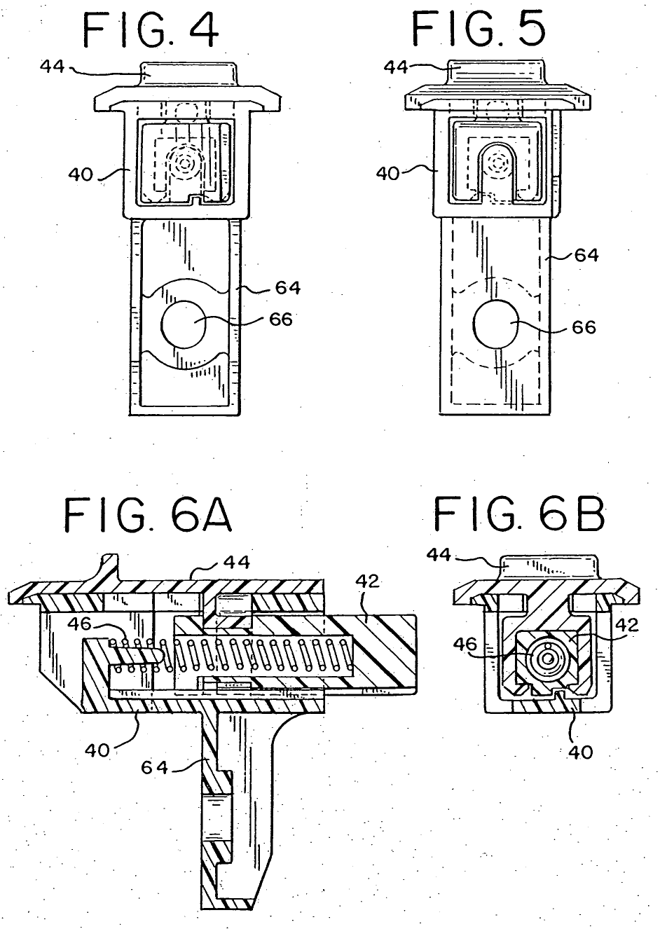

As shown in FIGS. 2-6B, the tilt-latch 10 generally comprises a housing 40, a latch bolt 42, an actuator 44 and a spring 46. As further shown in FIG. 1, the housing 40 is adapted to be supported by the sash window 12. Although typically the housing 40 is supported by the top rail 20, it is possible that the housing could be affixed to and supported by other portions of the sash window 12, in alternative configurations, including the stiles 24,26 or the base 22. In a preferred embodiment, the housing 40 is designed to be mounted, substantially flush on the top rail 20. The latch bolt 42 is slidably disposed within the housing 40. The spring 46 is positioned between the housing 40 and latch bolt 42 to bias the latch bolt 42 from the housing 40. The actuator 44 is connected to the latch bolt 42 and is designed to retract the latch bolt 42 into the housing 40 against the biasing force of the spring 46.

As shown in one preferred embodiment in FIGS. 2-6B, the housing 40 generally has a box type structure defining a chamber 50 therein. The housing 40 has a cover 52 having opposing longitudinal edges. A pair of sidewalls 54 depend from the cover 52. The housing 40 may also have a bottom wall 56. If desired, the tilt-latch 10 could be designed wherein the housing 40 has an open bottom end with no bottom wall 56. The cover 52, sidewalls 54, and bottom wall 56 cooperate to form the chamber 50. The housing 40 also has an outward end opening 58 in communication with the chamber 50. Each sidewall 54 has an opening 60 therethrough in communication with the chamber 50. The end of the housing 40 opposite the outward end opening 58 is closed by a rear wall 62 of the housing 40. Although preferably the housing 40 is closed by a rear wall 62, the end of the housing 40 opposite the outward end opening 58 may be open. The housing 40 further has a leg 64 that depends from the bottom wall 56. The leg 64 has a screw hole 66. Thus, in one preferred embodiment, the tilt-latch 10 is positioned in the header slot 34 and a screw is screwed through the hole 66 and into the sash window 12 to secure the tilt-latch 10 to the sash window 12.

The housing 40 is preferably of a one-piece, integral construction. The one-piece construction strengthens the housing and simplifies assembly. In one preferred embodiment, the housing 40 is an integral structure not formed from separate components connected together, or having slit cut into a wall of the housing 40. If desired, however, the housing 40 could also be made from multiple pieces. In addition, while a box-type housing structure is preferred, the housing 40 could also take other forms. For example, in place of a bottom wall 56, the housing 40 could include tabs extending from the sidewalls 54 to hold the latch bolt 42 in the housing 40. The spring 46 could be held any number of ways as known in the art.

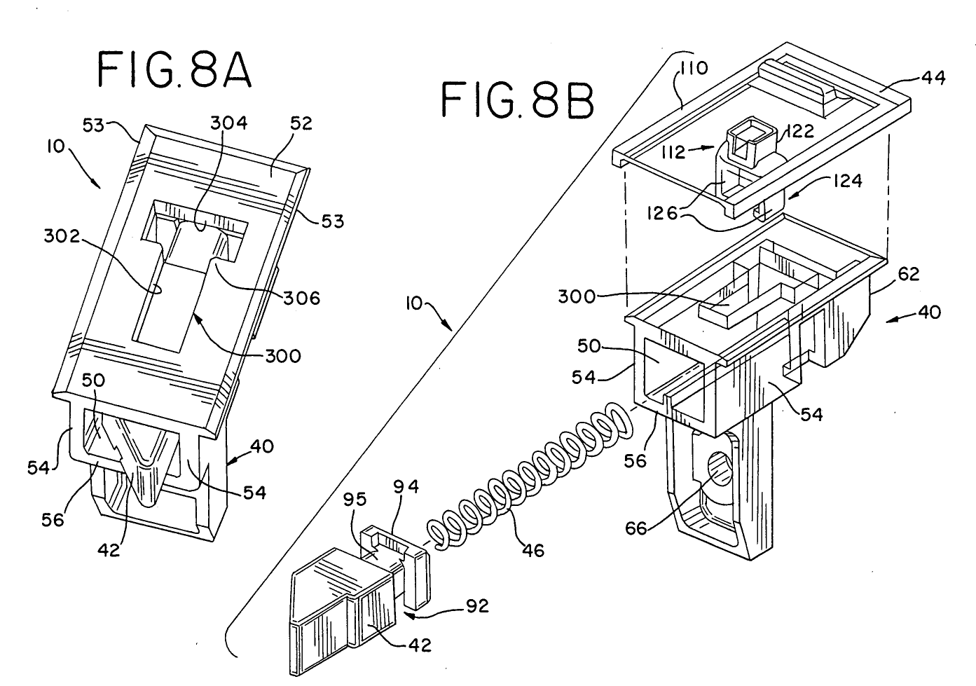

As further shown in FIGS. 2-6B, the cover 52 of the housing 40 has an aperture 68 therethrough. In one preferred embodiment, the aperture 68 is cross-shaped. In particular, the aperture 68 includes a first slot 70 that is generally parallel to the longitudinal edges of the cover 52. The first slot 70 has a first width. The aperture 68 further includes a second slot 76 centered along the first slot 70 and positioned generally transverse to the first slot 70. The second slot 76 has a second width that is greater than the first width. The second slot 76 thus extends past the first slot 70. Explained in an alternative fashion, the first slot 70 has a first portion 72 nearest the end of the housing 40 opposite the outward end opening 58. The first slot 72 further has a second portion 74 generally opposite the first portion 72 towards the outward end opening. An intermediate portion 73, generally represented by the second slot 76, is positioned between the first portion 72 and the second portion 74. In a preferred embodiment, the intermediate portion 73 or second slot 76 is generally at a midpoint of the first slot 70. It is understood that the aperture 68 could take other shapes. For example, the aperture 68 could be T-shaped as shown in FIGS. 8A and 8B, and as discussed in greater detail below.

As shown in FIGS. 2-9 and 14-15, the aperture 68 extends through the cover 52 and is in communication with the chamber 50. The cover 52 has an underside surface 78. A first segment 80 of the underside surface 78 generally adjacent to the first portion 72 of the first slot 70 defines a first retaining surface 82. The first segment 80 can further be defined by the underside surface 78 of the cover 52 at each longitudinal side of the first portion 72 of the first slot 70. A second segment 84 of the underside surface 78 generally adjacent to the second portion 74 of the first slot 70 defines a second retaining surface 86. The second segment 84 can further be defined by the underside surface 78 of the cover 52 at each longitudinal side of the second portion 74 of the first slot 70. The first and second retaining surfaces 82, 86 will be described in greater below.

As shown in FIGS. 2-6B, the latch bolt 42 is slidably disposed within the chamber 50 of the housing 40. The latch bolt 42 has a nose 88 adapted for engaging a respective one of the guide rails 16 on the master frame 14. When the latch bolt 42 is disposed within the housing 40, the latch bolt 42 may be in general cooperative sliding relation with the interior surfaces of the cover 52, sidewalls 54, and bottom wall 56 which form the chamber 50. While there is cooperative sliding engagement, it is not required that there be complete surface-to-surface engagement between the latch bolt 42 and the interior surfaces of the cover 52, sidewalls 54, and bottom wall 56. Although in the preferred embodiment the sidewalls 54 and bottom wall 56 are generally continuous surfaces, it is understood that the cover 52, sidewalls 54 and bottom wall 56 can each comprise discontinuous structures without departing from the spirit of the present invention. It is also understood that other structures may be utilized to accomplish such cooperative sliding arrangement between the latch bolt 42 and the housing 40. For example, the housing 40 can further comprise an interior tongue, while the latch bolt 42 further comprises a cooperatively dimensioned channel, such that the mating of the tongue and channel creates the cooperative sliding arrangement between the latch bolt 42 and the housing 40.

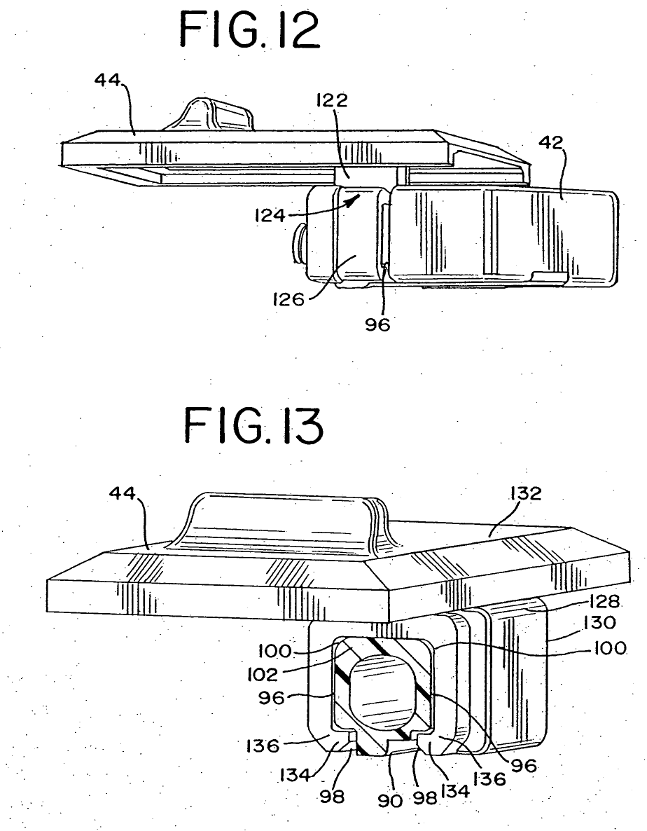

As shown in FIGS. 2-13, the latch bolt 42 has a spring wall 90 that is designed to engage or abut against one end of the spring 46. The spring wall 90 is defined by a hollowed out portion in the latch bolt 42 to form a pocket that receives one end of the spring 46. The spring 46 functions to bias the latch bolt 42 toward the outward end opening 58 and outboard of the housing 40. Preferably, the spring 46 is positioned in the chamber 50 and has one end abutting the spring wall 90 of the latch bolt 42 and another end abutting the rear wall 62 of the housing 40. The latch bolt 42 and housing 40 have cooperative structure to prevent the latch bolt 42 from being biased completely out of the housing 40. Although in a preferred embodiment the spring 46 is a compression spring, other configurations may be used. A tension spring, for example, may be used and configured in such a manner so as to bias the latch bolt 42 toward the outward end opening 58 of the housing 40. Other biasing members could also be used in place of the spring 46, which is a coil spring. For example, other types of springs can be used such as z-springs and leaf springs, although coil springs are preferred. Rubber or polymeric resilient members could also be used. In addition, resilient plastic member(s) could be integrally attached to the latch bolt 42 to bias the latch bolt 42 out of the outward end opening 58 of the housing 40. In sum, any structure could be used that will cause the latch bolt 42 to move back and forth. It is further understood that a biasing means is not required. The tilt-latch 10 could be adapted for manual retraction and extension of the latch bolt 42.

As further shown in FIGS. 2-13, the latch bolt 42 has a recessed portion 92 defining a receiver 94. The receiver 94 is adapted to receive and retain the actuator 44 so that the two components are cooperatively engaged or connected, thus defining a latch bolt/actuator combination. In a preferred embodiment, the receiver 94 is a neck 95 in the latch bolt 42 wherein the cross-sectional area of the neck 95 is less than the cross-sectional area of the latch bolt 42. The neck 95 is cooperatively dimensioned to receive and retain a member extending from the actuator 44 as described in greater detail below. The receiver 94 defines two engagement surfaces 96 and a pair of retaining lips 98. The receiver 94 also defines a pair of chamfered surfaces 100 at a top portion 102 of the latch bolt 42.

Although preferred embodiments are depicted in the FIGURES, it is understood that many varieties of receivers 94 can be used on the latch bolt 42, provided that each receiver is cooperatively dimensioned to receive and retain the actuator 44. For example, the receiver 94 could be an aperture in the latch bolt 42. The aperture would be cooperatively dimensioned to receive and retain a member extending from the actuator 44.

FIGS. 2-13 show the actuator 44. The actuator 44 generally includes a plate 110 and an attachment member 112. In a preferred form, the actuator 44 is a single integral component. The plate 110 is generally a planar body and sized to cover or blanket the entire cover 52 of the housing 40. The plate 110 has a pair of depending flanges 114 defined along opposed longitudinal edges of the plate 110. The flanges 114 slide along the edges of the cover 52 when the latch bolt 42 is retracted. The plate 110 has an outer surface 116 and an inner surface 118. The plate 110 has a fingerhold 120 on the outer surface 116. In a preferred embodiment, the fingerhold 120 is a control button extending outward from the surface 116, and adapted to be engaged by the operator's finger(s). Alternatively, the fingerhold 120 can be a recessed portion in the outer surface 116 of the plate 110 adapted to be engaged by the operator's finger(s). It is understood that the fingerhold 120 may take many forms, either extending above or recessed below the outer surface 116 of the actuator 44, however the fingerhold 120 must be adapted to receive and be engaged by the operators finger(s) such that the operator can actuate the actuator 44 by sliding it relative to the housing 40.

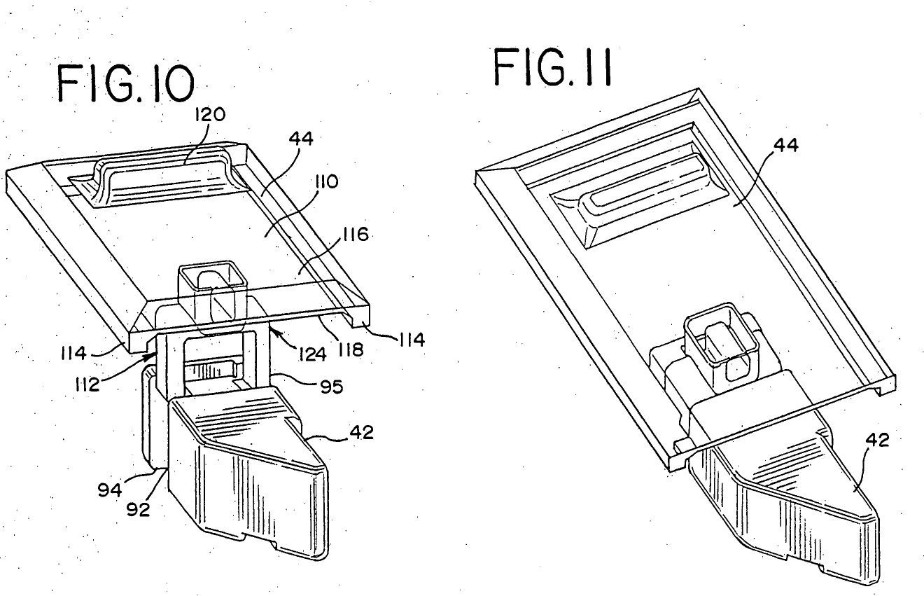

As further shown in FIGS. 2-13, the attachment member 112 depends from the inner surface 118 of the plate 110. The attachment member 112 generally includes a base 122 and a connector 124. The base 122 is generally a box-like structure directly connected to the inner surface 118 of the plate 110. The connector 124 depends from the base 122 away from the inner surface 118 of the actuator 44. The connector 124 includes a plurality of tines 126. In a preferred embodiment, the connector 124 has a pair of resilient tines 126. The tines 126 are cooperatively positioned and dimensioned to engage the receiver 94 of the latch bolt 42, as shown in FIGS. 10-13. Each tine 126 has a shoulder 128 at a proximal end 130 defining an engagement surface 132. Each tine 124 further has a tab 134 at a distal end 136 adapted to abut the latch bolt 42 as described in greater detail below.

It is understood that the connector 124 can take a variety of forms. It is further understood that the connector 124 and receiver 94 can take many different cooperative forms to engage and retain one another. For example, the connector 124 may be a cylindrical member while the receiver 94 of the latch bolt 42 is a cooperatively dimensioned cylindrical aperture. The connector 124 and receiver 94 can both be splined so as to increase the strength of the connection once the connector 124 and receiver 94 are engaged.

The assembly of the tilt-latch 10 of the present invention can be understood from FIGS. 2-13. First, the spring 46 is positioned against the spring wall 90 of the latch bolt 42, and then the spring 46 and latch bolt 42 are inserted into the housing 40 through the outward end opening 58. The spring 46 is positioned such that the other end of the spring 46 contacts the rear wall 62 of the housing 40. The latch bolt 42 is further inserted into the housing 40, compressing the spring 46, until the latch bolt 42 assumes an intermediate position to accept connection with the actuator 44. It is understood that the latch bolt 42 has at least three general positions. In an extended position, the nose 88 of the latch bolt 42 is biased out of the housing 40 by the spring 46 (e.g., FIG. 2). This also represents a latched position wherein the nose 88 can engage the guide rail 16 of the master frame 14 to latch the sash window 12 in a vertical position. The latch bolt 42 further has a retracted position wherein the latch bolt 42 is retracted into the housing 40 (e.g., FIG. 15). In a fully retracted position, the nose 88 of the latch bolt 42 is completely within the housing 40. In the retracted position, the nose 88 is disengaged from the guide rail 16 of the master frame 14 allowing the sash window 12 to be pivoted from the master frame 14. The latch bolt 42 further has an intermediate position generally between the extended position and the retracted position.

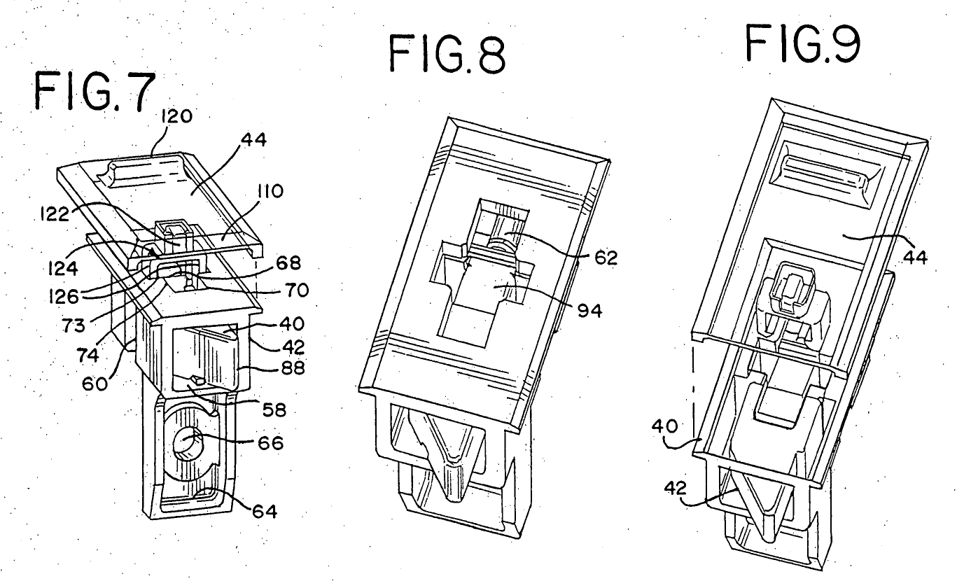

As shown in FIGS. 7-13, the actuator 44 is then connected to the latch bolt 42. The latch bolt 42 is partially retracted to the intermediate position, such as shown in FIG. 8. In the intermediate position, the receiver 94 of the latch bolt 42 is generally aligned with the second slot 74 of the aperture 68. This position represents a connecting position. The actuator 44 is positioned such that the outer surface 116 of the plate 110 faces away from the housing 40 and the inner surface 118 faces toward the housing 40, specifically, towards the aperture 68 of the housing 40. In this position, as shown in FIG. 9, the attachment member 112 extending from the inner surface 118 of the actuator 44 faces toward the aperture 68 of the housing 40. The connector 124 is generally aligned with the second slot 74 of the aperture 68. As can be seen, the connector 124 is wider than the first width of the first slot 70. The tines 126 of the connector 124 are inserted through the aperture 68 and specifically through the second slot 76. The tabs 134 of the tines 126 contact the receiver 94 of the latch bolt 42. As the tines 126 are resilient, the tines 126 deflect outwards and slide along the engagement surfaces 96 of the receiver 94. The chamfered surfaces 100 assist in a smooth engagement between the tines 126 and receiver 94. The openings 60 in the sidewalls 54 of the housing 40 accommodate the deflection of the tines 126. As the actuator 44 is further inserted through the second slot 74, the tabs 134 further slide along the latch bolt 42 until the tabs 134 pass a distal end of the receiver 94. Once in this position, the actuator 44 is connected to the latch bolt 42 wherein the tabs 134 engage the retaining lips 98 of the receiver 94 of the latch bolt 42.

Once the actuator 44 is connected to the latch bolt 42, the force applied to the latch bolt 42 to partially retract the latch bolt 42 for proper connection, can be removed. The spring 46 will then bias the latch bolt 42 to a fully extended position. It can be appreciated that the connection structure between the actuator 44, latch bolt 42 and housing 40 will maintain the latch bolt 42 within the housing 40 wherein the spring 46 cannot bias the latch bolt 42 completely from the housing 40. In this position, the plate 110 completely covers the cover 52 of the housing 40. It is understood that the size and geometry of the latch bolt 42, actuator 44, and aperture 68 of the housing 40 will depend on the dimensions of the sash window and the location and size of the guide rails 16.

Once assembled, the tilt-latch 10 can be installed into a sash window 12 as shown in FIG. 1. The tilt-latch 10 is received in the header slot 34 and a screw fastener (not shown) is screwed through the screw hole 66.

The tilt-latch 10 has a latched position, an unlatched position, and an intermediate position(s) therebetween. In the latched position, the nose 88 of the latch bolt 42 extends from the outward end opening 58 of the housing 40, such that the nose 88 is capable of engaging the guide rails 16 of the master frame 14 (e.g., FIGS. 1-2). Thus, in the latched position, the latch bolt 42 is in an extended position. Further, in the latched position, the base 122 of the attachment member 112 is received by the second portion 74 of the first slot 70. In the unlatched position, an operator engages the actuator 44 to retract the latch bolt 42 wherein the nose 88 of the latch bolt 42 is retracted into the housing 40. The actuator 44 slides along the cover 52 of the housing 40 wherein a portion of the cover 52 is exposed. Further, the base 122 of the attachment member 112 moves along the first slot 76 and is received by the first portion 72 of the first slot 70. Although in a preferred embodiment, in the unlatched position, the latch bolt 42 is fully retracted into the housing 40, it is understood that a portion of the latch bolt 42 may remain extended from the housing 40, without departing from the spirit of the present invention. Thus, the full path of travel of the actuator/latch bolt combination with respect to the housing 40 is defined between the latched position and the unlatched position. The intermediate position of the actuator/latch bolt combination occurs between the latched position and the unlatched position. In a most preferred embodiment, the intermediate position occurs when the attachment member 112 is aligned with the second slot 76 of the cover 52.

As discussed, the tilt-latch 10 is actuated by an operator moving the actuator 44 against the biasing force of the spring 46 from the from the latched position towards the unlatched position. This retracts the latch bolt 42 into the housing 44 causing the nose 88 of the latch bolt 42 to disengage the guide rail 16 of the master frame 14 of the sash window assembly 11. As shown in FIG. 1, when the noses 88 of opposed tilt-latches 10 on the top rail 20 fully disengage from the guide rails 16, the sash window 12 is free to pivot away from the master frame 14. Although in a preferred embodiment the nose 88 of the tilt-latch fully disengages the guide rail 16 when the actuator/latch bolt combination is in the unlatched position, it is understood that the nose 88 of the tilt-latch 10 may fully disengage the guide rail 16 when the actuator/latch bolt combination is in an intermediate position as well. Thus, in a preferred embodiment, the tilt-latch 10 is designed such that the nose 88 of the tilt-latch remains in engagement with the guide rail 16 until the actuator 44 reaches the unlatched position. Thus, operation of the tilt-latch of the present invention is accomplished by actuating the actuator 44 from the latched position to the unlatched position causing the nose 88 of the latch bolt 42 to disengage the respective guide rail 16 of the master frame 14. Once disengaged, the sash window 12 is free to rotate about the pivot-corner/balance shoe assembly 15 away from the master frame 16. Typically, a sash window 12 is equipped with two tilt-latches 10, one to engage each of the two guide rails 16 on the master frame 14. Thus simultaneous operation of both tilt-latches 10 is typically required in order to free the sash window 12 from the master frame 16 so that it can be pivoted.

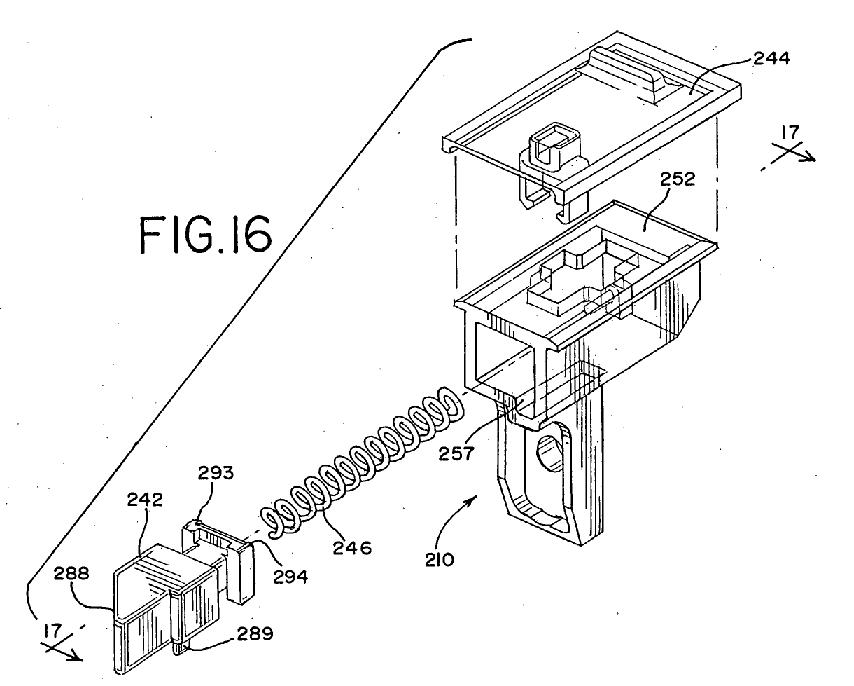

A second preferred embodiment of the tilt-latch is shown in FIGS. 16-20, generally referred to with the reference numeral 210. As seen in FIG. 16, the tilt-latch 210 generally comprises a housing 240, a latch bolt 242, an actuator 244 and a spring 246. Like the first preferred embodiment, the housing 240 is adapted to be supported by the sash window 12 as described above. Elements of the additional preferred embodiment that are substantially similar to corresponding elements of the first described preferred embodiment are referred to using similar reference numbers.

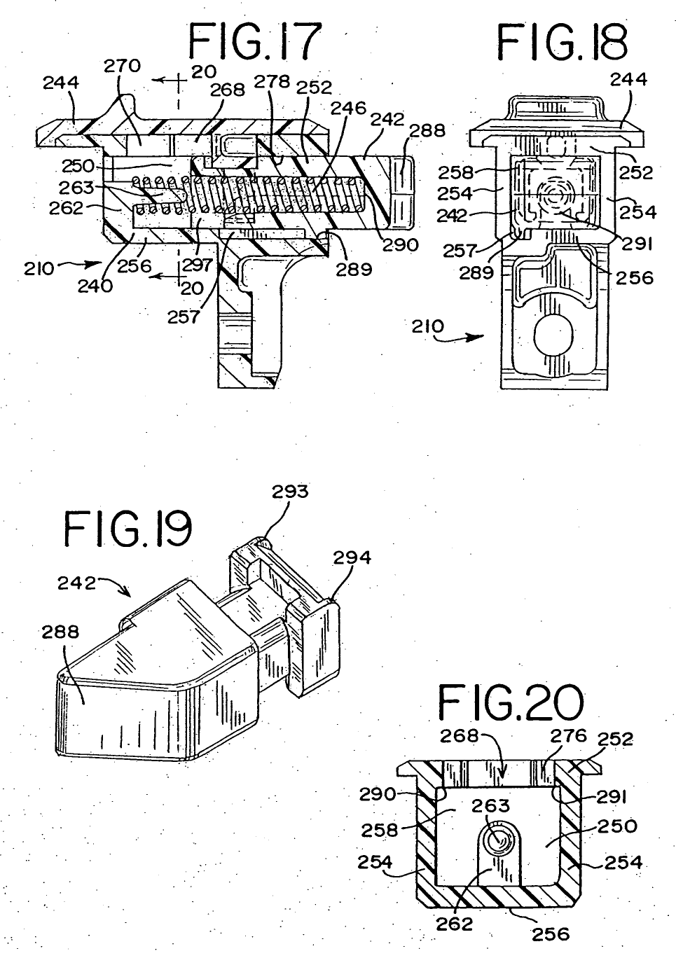

As further shown in FIGS. 16-20, the housing 240 generally has a box type structure defining a chamber 250 therein. The housing 240 has a cover 252 having opposing longitudinal edges. A pair of sidewalls 254 depend from the cover 252. The sidewalls 254 can be solid or contain a slot as in the previous embodiment. The housing 240 may also have a bottom wall 256. If desired, the tilt-latch 210 could be designed wherein the housing 240 has an open bottom end with no bottom wall 256. The cover 252, sidewalls 254, and bottom wall 256 cooperate to form the chamber 250. The housing 240 also has an outward end opening 258 in communication with the chamber 250. The end of the housing 240 opposite the outward end opening 258 is closed by a rear wall 262 of the housing 240. The rear wall 262 includes a spring post 263 adapted to receive the spring 246. The bottom wall 256 includes a longitudinal channel 257 (FIG. 18) adapted to receive a portion of the latch bolt 242 to assist in tracking the sliding of the latch bolt 242 in the housing 240. The longitudinal channel 257 is generally positioned at a lateral end of the bottom wall 256, although other positions along the bottom wall 256, or the housing 240 are possible.

As also shown in FIGS. 16, 17 and 20, the cover 252 of the housing 240 has an aperture 268 therethrough. Preferably as shown in FIG. 16, the aperture 268 is similarly cross-shaped as previously shown in FIGS. 3 and 8. In particular, the aperture 268 includes a first slot 270 that is generally parallel to the longitudinal edges of the cover 252. The first slot 270 has a first width. The aperture 268 further includes a second slot 276 centered along the first slot 270 and positioned generally transverse to the first slot 270. The second slot 276 has a second width that is greater than the first width. The second slot 276 thus extends past the first slot 270. As shown in FIGS. 16 and 20, the aperture 268 extends through the cover 252 and is in communication with the chamber 250. The cover 252 has an underside surface 278. The width of the underside surface 278 is greater than the width of the second slot 276 (the second width). Thus, the underside surface 278 of the cover 252 includes two track portions 290, 291 (FIG. 20) positioned between the second slot 276 and each respective sidewall 254. The tracks 290, 291 cooperate to form a ceiling to prevent a portion of the latch bolt 242 from departing the chamber 250 and passing through the aperture 268.

The latch bolt 242 is slidably disposed within the chamber 250 of the housing 240. The latch bolt 242 has a nose 288 adapted for engaging a respective one of the guide rails 16 on the master frame 14. When the latch bolt 242 is disposed within the housing 240, the latch bolt 242 may be in general cooperative sliding relation with the interior surfaces of the cover 252, sidewalls 254, and bottom wall 256 which form the chamber 250. The latch bolt 242 includes a tongue 289 cooperatively dimensioned with the channel 257 in the bottom wall 256 of the housing 240. The mating of the tongue 289 and channel 257 creates a cooperative sliding arrangement between the latch bolt 242 and the housing 240. The position of the tongue 289 can vary as discussed. The cooperative arrangement between the tongue 289 and the channel 257 serves as a locating feature for proper installation.

As shown in FIGS. 16, 17 and 20, the latch bolt 242 has a spring wall 290 that is designed to engage or abut against one end of the spring 246. The spring 246 functions to bias the latch bolt 242 toward the outward end opening 258 and outboard of the housing 240. The spring 246 is positioned in the chamber 250 over the post 263 and has one end abutting the spring wall 290 of the latch bolt 242 and another end abutting the rear wall 262 of the housing 240. The end of the latch bolt 242 opposite the nose 288 includes an aperture 297. The aperture 297 is cooperatively dimensioned with the spring post 263 to permit the post 263 to slide through the aperture 297 and past the spring wall 290 of the latch bolt 242 as the spring 246 is compressed. Thus, as the latch bolt 242 is moved from the latched position to the unlatched position, and the latch bolt 242 is retracted into the housing 244, the spring 246 compresses between the rear wall 262 of the housing 240 and the spring wall 290 of the latch bolt 242. As the spring 246 compresses, the spring post 263 is permitted to slide through the aperture 297 and towards the spring wall 290. Thus the purpose of the aperture 263 in the latch bolt 242 is to prevent interference of the spring post 263 with the latch bolt 242 during actuation of the tilt-latch 210.

The latch bolt 242 further includes a pair of retainers 293, 294. The retainers 293, 294 are located on the top surface of the latch bolt 242 at the end opposite from the nose 288. The retainers 293, 294 are positioned and cooperatively dimensioned with the tracks 290, 291 of the underside 278 of the cover 252. As the latch bolt 242 is actuated and retracted into the housing 240, the retainers 293, 294 ride along the tracks 290, 291 to assist in retaining the latch bolt 242 in the chamber 250. The retainers 293, 294 help prevent the latch bolt 242 from escaping the chamber 250 through the aperture 268 when the retainers 293, 294 are in the vicinity of the second slot 276. Thus the confronting relation of the retainers 293, 294 and the tracks 290, 291 keep the latch bolt 242 beneath the cover 252 and in the chamber 250. Mounting and operation of the tilt-latch 210 is similar as described above. This structure also helps prevent unwanted clicking noises upon movement of the latch bolt 242 within the housing 240.

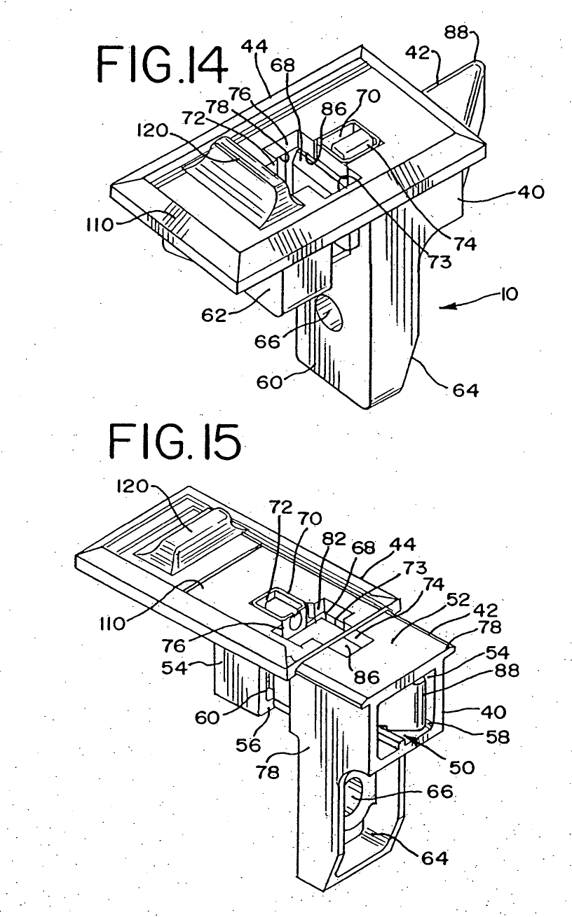

The tilt-latch 10, 210 of the present invention is designed to generally prevent or resist disassembly or disconnection of the actuator 44 from the latch bolt 42. Once the actuator 44 is connected to the latch bolt 42, as discussed above, it is prevented from disengagement. Generally, the attachment member 112 is dimensioned and designed so as to be unable to pass through the second portion 74 of the first slot 70. As shown in FIG. 14, the plate 110 being shown transparent for clarity, when the tilt-latch 10 is in the latched position, the base 122 of the attachment member 112 is received in the second portion 74 of the first slot 70. The respective shoulders 128 of the attachment member 112 pass beneath the second portion 74 and are generally adjacent to, or in confronting relation to the second retaining surface 86 defined by the underside surface 78 of the cover 52. In this position, the actuator 44 is prevented from being disconnected from the latch bolt 42 as the shoulders 128 are adapted to engage the second retaining surface 86. Attempting to force the actuator 44 away from the housing 40 results in the shoulders 128 engaging the second retaining surface 86, preventing or resisting the attachment member 112 from being retracted through the aperture 68. This attempted movement could be caused by positive actions of an operator or by wind loads acting on the sash window assembly 11. Thus, this structural configuration prevents or resists the actuator 44 from being disconnected from the latch bolt 42 when the tilt-latch 10 is in the latched position.

The tilt-latch 10,210 of the present invention is also designed to generally prevent or resist disassembly or disconnection of the actuator 44 from the latch bolt 42, when the tilt-latch is in the unlatched position. Generally, the attachment member 112 is dimensioned and designed so as to be unable to pass through the first portion 72 of the first slot 70. As shown in FIG. 15, the plate 110 shown transparent for clarity, when the tilt-latch 10 is in the unlatched position, the latch bolt 42 is retracted wherein the base 122 of the attachment member 112 is received in the first portion 72 of the first slot 70. The respective shoulders 128 of the attachment member 112 pass beneath the first portion 72 and are generally adjacent to, or in confronting relation to the first retaining surface 82 defined by the underside surface 78 of the cover 52. In this position, the actuator 44 is prevented from being disconnected from the latch bolt 42 as the shoulders 128 are adapted to engage the first retaining surface 82. Attempting to force the actuator 44 away from the housing 40 results in the shoulders 128 engaging the first retaining surface 82, preventing the attachment member 112 from being retracted through the aperture 68. This attempted movement could be caused by positive actions of an operator or by wind loads acting on the sash window assembly 11. Thus, this structural configuration prevents or resists the actuator 44 from being disconnected from the latch bolt 42 when the tilt-latch 10 is in the unlatched position.

Accordingly, the structural configuration of the tilt-latch 10,210 prevents or resists the actuator 44 from becoming disconnected from the latch bolt 42 when the tilt-latch 10 is in either the latched position or the unlatched position. Only when the latch bolt 42 is positioned in the intermediate position, is there an opportunity for the actuator 44 to be disconnected from the latch bolt as in this position, the attachment member 112 is aligned with the second slot 76. Only in this position can the shoulders 128 pass by the underside 78 of the cover 52, e.g. through the second slot 76. This configuration makes it unlikely that the actuator 44 can be inadvertently disconnected from the latch bolt 42.

Also, the tilt-latch 10,210 is designed so as to generally prevent disconnection of the actuator 44 from the latch bolt 42 when the actuator/latch bolt combination is in an intermediate position. As shown in FIGS. 11-13, when the actuator/latch bolt combination is in an intermediate position, the attachment member 112 is aligned with the second slot 76 of the aperture 68. Even when the attachment member 112 is aligned with the second slot 76 of the aperture 68, the actuator 44 is prevented from being disconnected from the latch bolt 42 by the attachment member 112. Specifically, attempting to force the actuator 44 away from the housing 40 results in the tabs 134 of the tines 126 confronting the retaining lips 98 of the receiver 94 on the latch bolt 42. This prevents or resists the actuator 44 from being disconnected from the latch bolt 42. It is understood that with the tilt-latch 10 in the intermediate position wherein the attachment member 112 is aligned with the second slot 76, and with sufficient force applied to the actuator 44, the tines 126 may deflect enough wherein the tabs 134 pass by the receiver 94 allowing disconnection. Such force, however, will likely cause destruction to the tabs 134.

The structural configuration of the tilt-latch 10,210 provides a secure connection between the actuator 44 and the latch bolt 42. This configuration makes it unlikely that the actuator 44 could be inadvertently disconnected from the latch bolt 42 since at the very least, the latch bolt 42 must be in the intermediate position where the attachment member 112 is aligned with the second slot 76 of the aperture 68. Furthermore, cooperation of the shoulders 128 and retaining surfaces 82,86 of the housing 40 prevents or resists disconnection of the actuator 44. This configuration further allows the housing 40 to be constructed as a single, integral component rather than from multiple pieces or having a split in one of its walls to allow for deflection for insertion of the latch bolt 42. A single, integral housing 40 provides enhanced rigidity.

FIGS. 8A and 8B show another preferred embodiment of a tilt-latch 10 according to the present invention. The embodiment of FIGS. 8A and 8B is similar in many ways to the first preferred embodiment discussed above and shown in FIGS. 2-6B. Features of the embodiment of FIGS. 8A and 8B that are similar or identical to those of the first preferred embodiment are referred to with identical reference numerals in the drawings.

The tilt latch 10 of the this embodiment generally includes a housing 40, a latch bolt 42, an actuator 44 and a spring 46. The housing 40 is preferably designed to mounted, substantially flush on or in a top rail, as with the previously described embodiment. The latch bolt 42 is slidably disposed within the housing 40. The spring 46 is positioned between the housing 40 and the latch bolt 42 to bias the latch bolt 42 from the housing 40. The actuator 44 is connected to the latch bolt 42 and is designed to retract the latch bolt 42 into the housing 40 against the biasing force of the spring 46.

The housing 40 includes a cover 52 having opposed longitudinal edges 53, depending side walls 54 a bottom wall 56 and a rear wall 62 cooperating to define a chamber 50. The cover 52 has an aperture 300. The aperture 300 of the third preferred embodiment is generally T-shaped. The aperture 300 includes a first or longitudinal slot 302 that is generally parallel to the longitudinal edges 53 of the cover 52. The aperture also includes a second or lateral slot 304 generally perpendicular to the longitudinal edges 53 and extends beyond a width of the first slot 302. The second slot 304 is located proximal a rear end 306 of the first slot 302.

The latch bolt 42 is identical to the latch bolt 42 of the first described preferred embodiment and therefore also includes a recessed portion 92 defining a receiver 94 comprising a neck 95 in the latch bolt 42.

The actuator 44 is also identical to the latch bolt 42 of the first described preferred embodiment and therefore includes a plate 110 and an attachment member 112. The attachment member 112 depends from the plate 110 and includes a base 122 and a connector 124 comprising a plurality of tines 126. In the embodiment shown, the connector 124 comprises a pair of resilient tines 126. The base 122 is adapted to slide within the first slot 302 in a direction parallel with the longitudinal edges 53, as will be seen. The connector 124 is adapted to pass through the second slot 304 during assembly and to engage the receiver 94 during both assembly and operation, as will be seen.

To assemble the tilt latch 10, the spring 46 is inserted into the chamber 50 such that it abuts against the rear wall 62. The latch bolt 42 is inserted into the chamber 50 such that it abuts against the spring 46, as shown in the exploded view of FIG. 8B. The latch bolt 42 is then slid within the chamber 50 against the biasing force of the spring 46 until the neck 95 is generally aligned with the lateral or second slot 304 as shown in FIG. 8A. This configuration generally represents the connecting position of the latch bolt 42. With the latch bolt 42 in this aligned position, the actuator 44 is connected to the latch bolt 42 by passing the connector 124 through the second slot 302 such that the tines 126 engage the neck 95 and receiver 94. Once the actuator 44 has been connected to the latch bolt 42 in this way, the latch bolt 42 may be released and the tilt latch 10 operated in a similar manner to that described above in connection with the first described preferred embodiment. Also, the third preferred embodiment of FIGS. 8A and 8B may be assembled to a sash window 12 as previously described. It is understood that any of the alternative features discussed above in connection with the previously described embodiments as being applicable thereto, are equally applicable to the presently described third preferred embodiment. Also, the second or lateral slot 304 may be positioned at any location along the first slot 302. As will be appreciated, the actuator 44 can only be connected to the latch bolt 42 when the receiver 94 is aligned with the lateral slot 304 of the aperture 300. As discussed above, similar cooperating structures resists detachment of the actuator 44 from the latch bolt 42.

While the specific embodiments have been illustrated and described, numerous modifications come to mind without significantly departing from the spirit of the invention and the scope of protection is only limited by the scope of the accompanying Claims.

What is claimed is:

1. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having an aperture;
a latch bolt disposed within the housing, the latch bolt having an extended position, an intermediate position and a retracted position;
an actuator connected to the latch bolt through the aperture, the actuator being connectable with the latch bolt only when the latch bolt is in the intermediate position.

2. The tilt-latch of claim 1 further comprising means for biasing the latch bolt through the outward end opening.

3. The tilt-latch of claim 1 wherein the housing further has a cover, the aperture being positioned in the cover.

4. The tilt-latch of claim 1 wherein the aperture comprises a first slot having a first width and a second slot extending beyond the width of the first slot.

5. The tilt-latch of claim 1 wherein the actuator further has a member passing through the aperture and connected to the latch bolt.

6. The tilt-latch of claim 5 wherein the member has a tine adapted to engage the latch bolt.

7. The tilt-latch of claim 6 wherein the latch bolt further has a recessed portion, wherein the plurality of tines engage the recessed portion.

8. The tilt-latch of claim 7 wherein the recessed portion defines an retaining lip, and wherein the tine has a tab, the tab engaging the retaining lip when the actuator is connected to the latch bolt.

9. The tilt-latch of claim 5 wherein the member has a pair of tines.

10. The tilt-latch of claim 4 wherein the actuator further has a member passing through the aperture and connected to the latch bolt.

11. The tilt-latch of claim 10 wherein the member has a base.

12. The tilt-latch of claim 11 wherein the base is received in a first portion of the first slot when the latch bolt is in the retracted position.

13. The tilt-latch of claim 11 wherein the base is received in a second portion of the first slot when the latch bolt is in the extended position.

14. The tilt-latch of claim 1 wherein the actuator has an attachment member having a shoulder, the shoulder being in confronting relation to a retaining surface of the housing when the latch bolt is in the extended position.

15. The tilt-latch of claim 1 wherein the actuator has an attachment member having a shoulder, the shoulder being in confronting relation to a retaining surface of the housing when the latch bolt is in the retracted position.

16. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening;
a latch bolt disposed within the housing, the latch bolt having an extended position, an intermediate position and a retracted position;
an actuator connected to the latch bolt, wherein the housing, latch bolt and actuator having cooperative structure such that the actuator is connectable with the latch bolt only when the latch bolt is in the intermediate position.

17. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having an aperture;
a latch bolt disposed within the housing, the latch bolt having a nose adapted for engaging a respective one of the guide rails, the latch bolt having an extended position, an intermediate position and a retracted position; and
an actuator having a member connecting the actuator and the latch bolt, the member being adapted to pass through the aperture and engaging the latch bolt when the latch bolt is in the intermediate position, the member further being adapted to be unable to pass through the aperture when the latch bolt is in either the extended or retracted positions.

18. The tilt-latch of claim 17 further comprising means for biasing the latch bolt through the outward end opening.

19. The tilt-latch of claim 17 wherein the housing further has a cover, the aperture being positioned in the cover.

20. The tilt-latch of claim 17 wherein the member has a plurality of tines adapted to engage the latch bolt.

21. The tilt-latch of claim 20 wherein the latch bolt further has a recessed portion, wherein the plurality of tines engage the recessed portion.

22. The tilt-latch of claim 21 wherein each tine has a tab and the recessed portion defines retaining lips, wherein the tabs engage the retaining lips when the actuator is connected to the latch bolt.

23. The tilt-latch of claim 17 wherein the member has a shoulder and the housing defines a first retaining surface and a second retaining surface.

24. The tilt-latch of claim 23 wherein the shoulder is in confronting relation to the first retaining surface when the latch bolt is in the retracted position.

25. The tilt-latch of claim 23 wherein the shoulder is in confronting relation to the second retaining surface when the latch bolt is in the extended position.

26. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having an aperture;
a latch bolt disposed within the housing, the latch bolt having an extended position, a connecting position and a retracted position; and
an actuator releasably connected to the latch bolt when latch bolt is in a connecting position, and means for preventing the actuator from being disconnected from the latch bolt when the latch bolt is spaced from the connecting position.

27. The tilt-latch of claim 26 further comprising means for biasing the latch bolt through the outward end opening.

28. The tilt-latch of claim 26 wherein the housing further has a cover, the aperture being positioned in the cover.

29. The tilt-latch of claim 26 wherein the housing is an integral structure.

30. The tilt-latch of claim 26 wherein the housing is a one-piece integral structure.

31. The tilt-latch of claim 26 wherein the actuator further has a member connecting the actuator to the latch bolt.

32. The tilt-latch of claim 31 wherein the member has a plurality of tines engaging the latch bolt.

33. The tilt-latch of claim 32 wherein the latch bolt further has a recessed portion, wherein the plurality of tines engage the recessed portion.

34. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having a cover, the cover having an aperture, the aperture have a first slot having a width, the aperture further having a second slot extending past the width of the first slot;
a latch bolt disposed within the housing, the latch bolt having an extended position, an intermediate position and a retracted position; and
an actuator having a member that passes through the second slot to connect to the latch bolt.

35. The tilt-latch of claim 34 further comprising means for biasing the latch bolt through the outward end opening.

36. The tilt-latch of claim 34 wherein member further has a base.

37. The tilt-latch of claim 23 wherein the member slides along the first slot when the actuator is moved from the extended position to the retracted position.

38. The tilt-latch of claim 34 wherein the member has a plurality of tines adapted to engage the latch bolt.

39. The tilt-latch of claim 34 wherein the member cannot pass through the first slot.

40. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having an aperture;
a latch bolt disposed within the housing, the latch bolt having an extended position and a retracted position;
an actuator connected to the latch bolt through the aperture; and
means for preventing the actuator from being disconnected from the latch bolt when the latch bolt is in the extended position.

41. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having an aperture;
a latch bolt disposed within the housing, the latch bolt having an extended position and a retracted position;
an actuator connected to the latch bolt through the aperture; and
means for preventing the actuator from being disconnected from the latch bolt when the latch bolt is in the retracted position.

42. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having a cover having an aperture, the cover having an underside surface defining a retaining surface;
a latch bolt disposed within the housing, the latch bolt having an extended position, an intermediate position and a retracted position; and
an actuator having a member passing through the aperture to connect to the latch bolt when the latch bolt is in the intermediate position, the member being in confronting relation to the retaining surface when the latch bolt is not in the intermediate position.

43. The tilt-latch of claim 42 wherein the aperture has a first slot having a width, the aperture further having a second slot extending past the width of the first slot.

44. The tilt-latch of claim 43 wherein the member passes through the second slot to connect to the latch bolt when the latch bolt is in the intermediate position.

45. The tilt-latch of claim 43 wherein the member has a base, the base slideable within the first slot.

46. The tilt-latch of claim 42 wherein the member has a shoulder, the shoulder being in confronting relation to the retaining surface when the latch bolt is not in the intermediate position.

47. The tilt-latch of claim 43 wherein the retaining surface comprises a first retaining surface adjacent a first portion of the first slot.

48. The tilt-latch of claim 47 wherein the member has a shoulder wherein the shoulder is in confronting relation to the first retaining surface when the latch bolt is in the retracted position.

49. The tilt-latch of claim 48 wherein the retaining surface comprises a second retaining surface adjacent a second portion of the first slot.

50. The tilt-latch of claim 49 wherein the shoulder is in confronting relation to the second retaining surface when the latch bolt is in the extended position.

51. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having a cover, the cover having an aperture, the cover further having an underside surface defining a track portion;
a latch bolt disposed within the housing, the latch bolt having an extended position and a retracted position, the latch bolt further having a retainer, the retainer being in confronting relation to the track portion; and
an actuator having a member that passes through the aperture to connect to the latch bolt.

52. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having a cover, the cover having an aperture, the housing further having a channel;
a latch bolt disposed within the housing, the latch bolt having an extended position and a retracted position, the latch bolt further having a tongue, the tongue being received in the channel; and
an actuator having a member that passes through the aperture to connect to the latch bolt.

53. A method of assembling a tilt-latch for a sash window disposed within opposed guide rails on a master frame, the tilt-latch adapted for releasably securing the sash window to the master frame, the method comprising the steps of
providing a housing adapted to be supported by the sash window, the housing having an outward end opening, the housing further having an aperture, the aperture having a first portion, a second portion, and an intermediate portion between the first portion and the second portion;
providing a latch bolt, the latch bolt having an extended position, an intermediate position and a retracted position, the latch bolt further having a nose adapted for engaging a respective one of the guide rails;
providing an actuator slideable along the housing, the actuator having a member extending therefrom, the member having a base and a connector, the base being adapted to pass through the first and second portions of the aperture, the connector being adapted to pass through the intermediate portion of the aperture;
sliding the latch bolt into the housing and further sliding the latch bolt to the intermediate position;
inserting the connector through the intermediate portion of the elongated opening; and
engaging the connector with the latch bolt.

54. A tilt-latch for a sash window disposed within opposed guide rails on a master frame, the tilt-latch adapted for releasably securing the sash window to the master frame, the tilt-latch comprising:
a housing adapted to be supported by the sash window, the housing having an outward end opening, the housing further having a T-shaped aperture comprising a longitudinal slot having a width and a lateral slot extending past the width of the longitudinal slot;
a latch bolt disposed within the housing, the latch bolt having an extended position and a connecting position;
an actuator connected to the latch bolt through the aperture, the actuator being connectable with the latch bolt only when the latch bolt is in the connecting position.

55. The tilt-latch of claim 54 further comprising means for biasing the latch bolt through the outward end opening.

56. The tilt-latch of claim 54 wherein the housing further has a cover, the T-shaped aperture being positioned in the cover.

57. The tilt-latch of claim 54 wherein the actuator further has a member passing through the lateral slot of the T-shaped aperture and connected to the latch bolt when the latch bolt is in the connecting position.

58. The tilt-latch of claim 57 wherein the member has a plurality of tines adapted to engage the latch bolt.

59. The tilt-latch of claim 58 wherein the latch bolt further has a recessed portion, wherein the plurality of tines engage the recessed portion.
